(19) United States
(12) Patent Application Publication
(10) Pub. No.: US 2017/0356581 A1
(43) Pub. Date: Dec. 14, 2017

(54) QUICK CONNECTOR

(71) Applicant: ILLINOIS TOOL WORKS INC., Glenview, IL (US)

(72) Inventors: Jason K. TROTTER, Des Plaines, IL (US); Dennis M. MARK, Buffalo Grove, IL (US)

(21) Appl. No.: 15/526,916

(22) PCT Filed: Nov. 18, 2015
(86) PCT No.: PCT/US2015/061318

§ 371 Date: May 15, 2017

Related U.S. Application Data
(60) Provisional application No. 62/082,436, filed on Nov. 20, 2014.

(51) Int. Cl. F16L 37/088

(52) U.S. Cl. CPC F16L 37/088

(57) ABSTRACT

A quick connector assembly incorporating a substantially non-circular, compressible sealing element in a connector housing. Upon insertion of a male adaptor, the male adaptor directly or indirectly applies an axial compressive force, thereby causing the sealing element to compress and/or reshape upon continued insertion until final assembly is complete.

### CROSS-REFERENCE TO RELATED APPLICATIONS

This non-provisional application claims the benefit of, and priority from, copending U.S. Provisional Application 62/082,436 having a filing date of Nov. 20, 2014. The contents of such earlier application and all other documents referenced herein are hereby incorporated by reference as if set forth in their entirety

### TECHNICAL FIELD

The present disclosure relates generally to fluid line systems which include quick connector couplings. In particular, the present disclosure relates to quick connectors adapted for use in transportation vehicles such as automobiles, aircraft and the like to establish and maintain reliable connections in various fluid line systems such as coolant systems, hydraulic systems and the like.

### BACKGROUND

In automotive and other fields, quick connector assemblies are often used to provide a fluid connection between two components or conduits. Such quick connector assemblies typically include a male adaptor which is received and sealingly retained in a plastic or metal female connector housing. Within the connector housing, an O-ring sealing element is typically seated within a groove bordered by a sealing ring which is fixed in place by welding or the like so as to block the O-ring sealing element against undesired axial movement. A spring clamp of metal or the like is positioned rearward of the sealing ring between the sealing ring and the housing entrance. As the male adaptor (over which a hose or other structure is mounted) is inserted into the connector housing entrance, the spring clamp is first engaged and caused to deform radially. As the male adaptor is advanced further into the connector housing a distal end of the male adaptor is forced through the O-ring sealing element, thereby causing the O-ring sealing element to expand radially. Upon full insertion of the male adaptor into the housing, the spring clamp falls into a radial groove on the male adaptor, thereby blocking both axial and rotational displacement of the male adaptor. At the same time, the O-ring sealing element is captured between the distal end of the male adaptor and the connector housing to provide a fluid tight seal.

While prior quick connector configurations have provided excellent performance, they may require the application of substantial force in order to establish the initial connection. In particular, a significant amount of force may be required to push the distal end of the male adaptor through the O-ring sealing element so as to cause the required radial expansion of the O-ring sealing element. Some users may lack the physical strength necessary to carry out this function. Accordingly, a quick connector which reduces the insertion force necessary to establish a sealed connection between the connector housing and the male adaptor would be desirable.

### SUMMARY OF THE DISCLOSURE

The present disclosure provides advantages and alternatives over the prior art by providing a quick connector assembly incorporating a compressible sealing element adapted to reduce initial insertion force of a male adaptor. Upon insertion of a male adaptor into the connector housing, the compressible sealing element is caused to compress and/or reshape upon continued insertion until final assembly is complete. Initial resistance is substantially reduced as the sealing surface of the male adaptor moves past the sealing element. Overall assembly is thereby simplified and made easier.

In accordance with one exemplary aspect, the present disclosure provides a quick connector assembly including a connector housing defining an axial through bore having a housing entrance. A male adaptor is provided for insertion into the connector housing through the housing entrance in substantially coaxial relation with the axial through bore. The male adaptor comprises a flared distal end having a nose portion. A compressible sealing element having a substantially non-circular, cross-sectional profile is disposed at a position within the connector housing. Upon initial insertion of the male adaptor into the connector housing, the nose portion of the male adaptor passes the compressible sealing element, and upon continued insertion of the male adaptor into the connector housing, the compressible sealing element is deformed by folding or reoriented to form a fluid-tight seal between the male adaptor and an opposing surface of the connector housing.

Other features and advantages of the disclosure will become apparent to those of skill in the art upon review of the following detailed description, claims and drawings.

### BRIEF DESCRIPTION OF THE DRAWINGS

FIG. 1 is a schematic, exploded perspective view illustrating an exemplary quick connector assembly incorporating a fixed retainer ring and O-ring sealing element in accordance with the prior art;

FIG. 2 is a schematic cut-away view illustrating an exemplary quick connector assembly incorporating a compressible sealing element in accordance with the present disclosure;

FIG. 3 is a schematic cross-sectional view illustrating the relation among the male adaptor and compressible sealing element in the quick connector assembly of FIG. 2;

FIGS. 4 and 5 illustrate alternative exemplary constructions for a compressible sealing element in a quick connector assembly in accordance with the present disclosure;

FIGS. 6 and 7 are schematic illustrations of an exemplary alternative construction quick connector assembly incorporating a compressible sealing element in accordance with the present disclosure; and

FIG. 8 is a schematic exploded view of the exemplary quick connector assembly of FIGS. 6 and 7.

Before the exemplary embodiments of the invention are explained in detail, it is to be understood that the invention is in no way limited in its application or construction to the details and the arrangements of the components set forth in the following description or illustrated in the drawings. Rather, the invention is capable of other embodiments and of being practiced or being carried out in various ways. Also, it is to be understood that the phraseology and terminology used herein are for purposes of description only and should not be regarded as limiting. The use herein of terms such as “including” and “comprising” and variations thereof is meant to encompass the items listed thereafter and equivalents thereof as well as additional items and equivalents thereof.

### DETAILED DESCRIPTION OF PREFERRED EMBODIMENTS

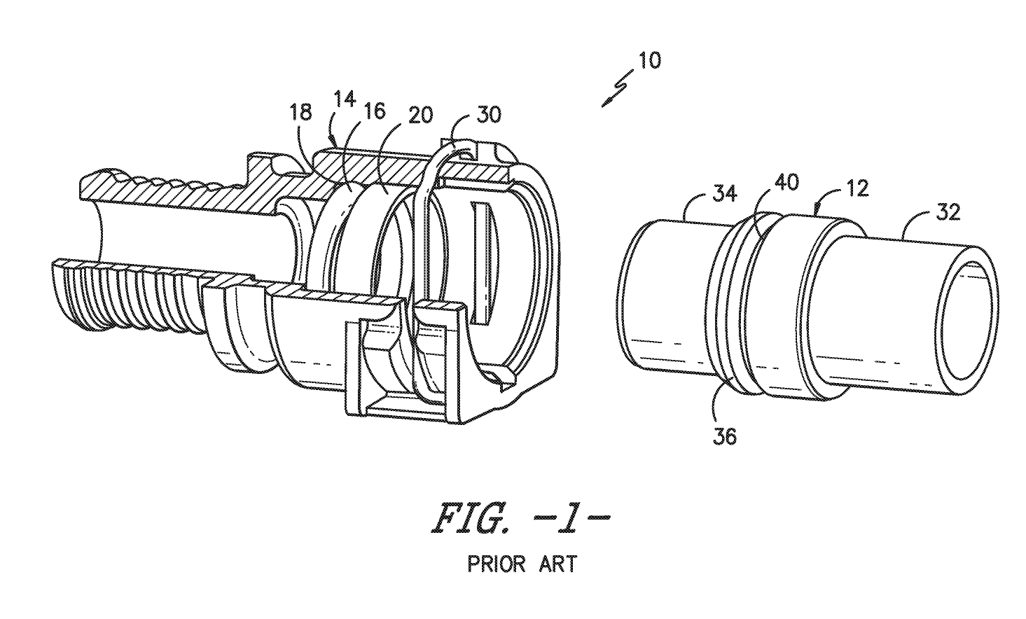

Reference will now be made to the drawings, wherein to the extent possible, like elements are designated by like reference numerals in the various views. In FIG. 1, an exemplary prior art quick connector assembly 10 is illustrated. Such quick connector assemblies typically include a male adaptor 12 which is received and sealingly retained in a plastic or metal female connector housing 14 defining a through bore. Within the connector housing 14, an O-ring sealing element 16 is typically seated within an O-ring groove 18 defined on one side by a sealing ring 20. In the prior art construction, the sealing ring 20 is fixed in place by welding or the like so as to contain the O-ring sealing element 16 within the O-ring groove 18. In this configuration, the O-ring sealing element 16 is substantially blocked against axial movement.

As illustrated, in the exemplary prior art construction, a spring clamp 30 of metal or the like is positioned rearward of the sealing ring 20. As shown, the spring clamp 30 may be of a generally ring-shaped configuration with a substantially elliptical or other non-circular geometry. The male adaptor 12 may include a proximal end 32 which matedly engages a hose or other structure (not shown). The male adaptor 12 also includes a distal end 34 which is adapted for insertion into the connector housing 14 in substantially coaxial relation to the housing through bore. An enhanced diameter intermediate collar 36 is disposed between the proximal end 32 and the distal end 34. A radial groove 40 is disposed within the intermediate collar 36. As the male adaptor 12 is inserted into the connector housing 14, the spring clamp 30 is first engaged and caused to deform radially outwardly by outward force from the distal end 34. As the male adaptor 12 is advanced further into the connector housing 14, the distal end 34 is forced through the O-ring sealing element 16, thereby causing the O-ring sealing element 16 to expand radially outwardly to fill the O-ring groove 18. Upon full insertion of the male adaptor 12 into the connector housing, the spring clamp 30 falls into the radial groove 40 at the intermediate collar 36. With the spring clamp 30 captured in the radial groove 40, the male adaptor 12 is blocked against axial displacement. The radial expansion of the O-ring sealing element 16 provides a fluid tight seal between the male adaptor 12 and the surrounding connector housing 14. In this configuration a sealed fluid passageway is established across the connector housing 14.

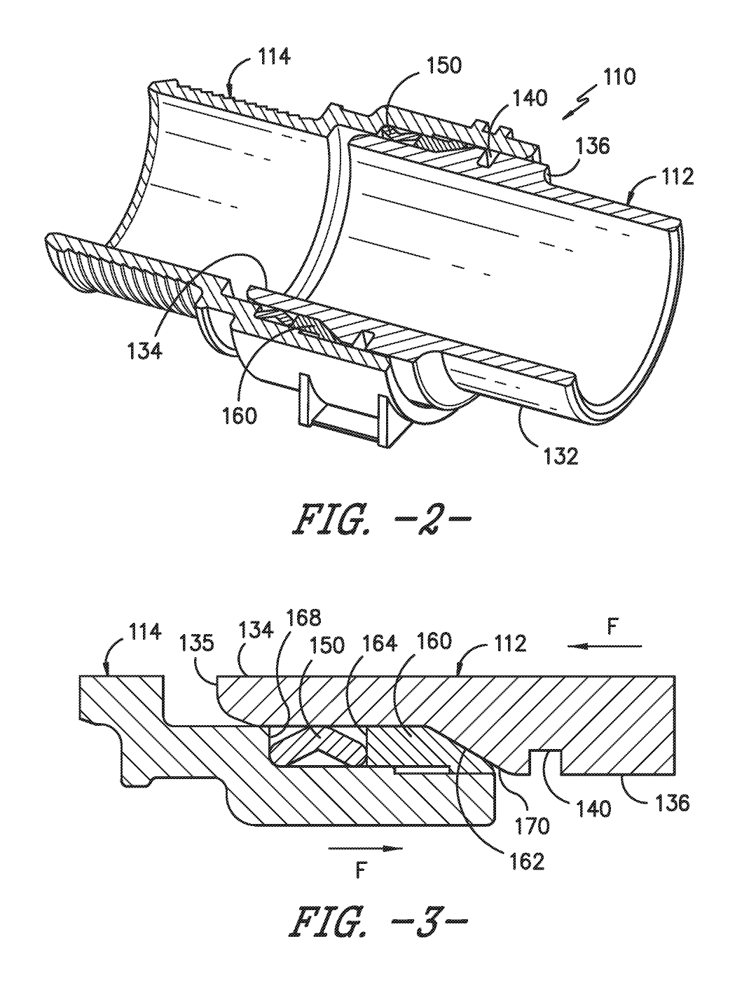

Referring now to FIGS. 2 and 3, an improved quick connector assembly 110 consistent with the present disclosure will now be described wherein elements corresponding to those previously described will be designated by like reference numerals within a 100 series. As illustrated, the quick connector assembly 110 includes a male adaptor 112 and a connector housing 114 defining an axial through bore. The male adaptor 112 and the connector housing 114 are adapted for mated engagement as illustrated by the force arrows in the various views.

As shown, the male adaptor 112 may have a configuration generally as described in reference to the prior art. In this regard, the male adaptor 112 may include a proximal end 132 which matedly engages a hose or other structure (not shown). The male adaptor 112 may also include a flared distal end 134 having a rounded nose 135 as best seen in FIG. 3 which is adapted for insertion into the connector housing 114. In the illustrated exemplary construction, an enhanced diameter intermediate collar 136 is disposed between the proximal end 132 and the distal end 134. A radial groove 140 may be disposed within the intermediate collar 136.

Referring jointly to FIGS. 2 and 3, it may be seen that the illustrated, exemplary quick connector assembly 110 includes a compressible sealing element 150 in combination with a floating retainer ring 160. This combination facilitates the insertion of the male adaptor 112 by reducing the force required during the initial stage of insertion. In particular, the use of the floating retainer ring 160 which may slide axially relative to the adjacent surface of the connector housing 114 permits early stage insertion forces to be minimized, while nonetheless permitting compression and reshaping of the compressible sealing element 150 to establish a fluid tight seal.

As best illustrated in FIG. 3, the floating retainer ring 160 may have a generally wedge-shaped cross-section construction incorporating a rear forward sloped face 162 projecting in a direction generally opposing the direction of male adaptor insertion. The floating retainer ring 160 may also include a forward face 164 which is adapted to engage and compress the compressible sealing element 150 as will be described further hereinafter.

Prior to insertion of the male adaptor 112 into the connector housing 114, the compressible sealing element 150 may be disposed in resting relation within the interior of the connector housing 114 adjacent to a supporting radial shoulder surface 168. In this regard, it will be understood that the compressible sealing element 150 may be a generally ring-shaped structure with a cross-section adapted for folding deformation upon the application of compression in the axial direction. In this regard, the cross-section of the compressible sealing element 150 may define one or more leg segments intersecting to form living hinges to facilitate such folding deformation. The compressible sealing element 150 may be formed from an elastomer with sufficient dimensional stability such that the sealing element 150 maintains a general ring structure within the connector housing 114 prior to use and does not fall out.

Prior to insertion of the male adaptor 112 into the connector housing 114, the floating retainer ring 160 may be disposed in floating relation between the compressible sealing element 150 and a sealing ring (not shown) as previously described in relation to FIG. 1. Thus, the floating retainer ring 160 is initially permitted to slide axially relative to the opposing surface of the connector housing 114 within a zone bordered by the compressible sealing element 150 and the sealing ring. Of course, other arrangements may likewise be used if desired.

As best seen in FIG. 3, in the exemplary construction, the male adaptor 112 may include a forward projecting sloped shoulder surface 170 defining a portion of flared distal end 134 in spaced apart relation to the rounded nose 135. The sloped shoulder surface 170 of the male adaptor 112 is adapted to contact and bear against the rear sloped face 162 of the floating retainer ring in the final assemble condition. In this final condition, the compressible sealing element 150 may be deformably compressed between the forward face 164 of the floating retainer ring 160 and the opposing radial shoulder surface 168. The compressible sealing element 150 is also compressed between flared distal end 134 and the opposing surface of the connector housing 114 thereby providing a fluid-tight seal. At the same time, axial withdrawal of the male adaptor 112 may be blocked by engagement between in the same manner as described in relation to FIG. 1.

As noted previously, a significant benefit of the quick connector assembly 110 is the reduction in the force required to achieve full insertion of the male adaptor 112. In this regard, upon initial insertion of the male adaptor 112, the male adaptor 112 will first contact the floating retainer ring 160 and will cause the floating retainer ring 160 to move axially forward generally into the position illustrated in FIG. 3 as the male adaptor 112 itself moves inwardly. As will be appreciated, during this initial stage of insertion, the male adaptor 112 encounters minimal resistance as the surface of the male adaptor moves over the compressible sealing element 150.

At the final stage of insertion, as axial force is applied to the male adaptor 112, the sloped shoulder surface 170 urges the floating retainer ring 160 progressively forward against the compressible sealing element 150 until the final locked relation is achieved. However, this final distance of movement by the floating retainer ring 160 may be quite short such that the overall insertion effort is still relatively minimal. In the final assembled condition, the compressible sealing element is compressed to a deformed shape thereby forming the desired sealed relationship.

As indicated previously, the compressible sealing element 150 may be a generally ring-shaped structure with a substantially non-circular cross-section adapted for folding deformation or reorientation upon the application of compression in the axial direction. In this regard, the compressible sealing element may have one or more leg segments with a length to thickness ratio greater than about 1.2 and more preferably a length to thickness ratio greater than about 2.0 and more preferably a length to thickness ratio greater than about 3.0. As illustrated in FIGS. 2 and 3, one possible configuration for the compressible sealing element 150 is an elastomer ring structure with a generally “V” shaped cross-section. As will be readily understood, as axial forces are applied, such a “V” configuration may undergo folding deformation at the living hinge formed at the intersection of the leg segments forming the “V”. Thus, the structure may fold in a hinging manner as the compressible sealing element 150 is pressed between the floating retainer ring 160 and the radial shoulder surface 168. As this folding takes place, the compressible sealing element 150 will be urged to adopt an increased height within its zone of confinement thereby pressing against the opposing surfaces of the male adaptor 112 and the connector housing 114 and establishing the desired sealed condition.

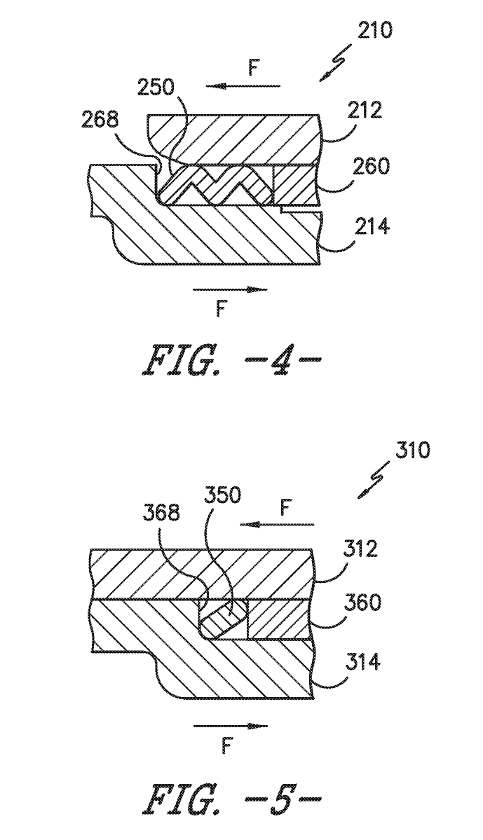

It is also contemplated that any number of other cross-sectional configurations may be used for a compressible sealing element within a quick connector assembly consistent with the present disclosure. By way of example only, and not limitation, FIG. 4 illustrates one exemplary configuration for a compressible sealing element 250 for use in a quick connection assembly 210 consistent with the present disclosure. In the embodiment illustrated in FIG. 4, a compressible sealing element 250 may be an elastomeric ring having a generally “M” shape or “W” shape cross section. Such a sealing element may be disposed in a compression zone bordered by the male adaptor 212, the connector housing 214 and the floating retainer ring 260 as previously described. Such a configuration may undergo folding deformation as axial forces are applied. More particularly, the structure may fold in a hinging manner as the compressible sealing element 250 is pressed between the floating retainer ring 260 and the radial shoulder surface 268. As this folding takes place, the compressible sealing element 250 will also be urged to adopt an increased height within its zone of confinement thereby pressing against the opposing surfaces of the male adaptor 212 and the connector housing 214 and establishing the desired sealed condition.

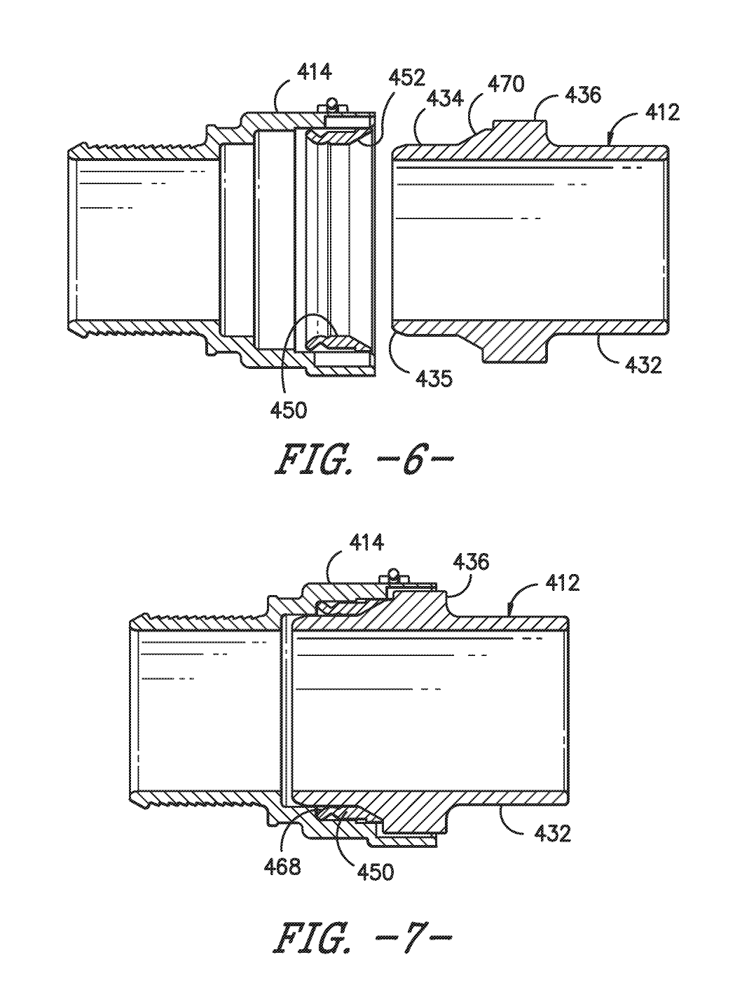

FIG. 5 illustrates yet another exemplary configuration for a compressible sealing element 350 for use in a quick connection assembly 310 consistent with the present disclosure. In the embodiment illustrated in FIG. 5, a compressible sealing element 350 may be an elastomeric ring having a generally tilted, elliptical cross section for disposition in a compression zone bordered by the male adaptor 312, the connector housing 314 and the floating retainer ring 360 as previously described. Such a configuration may undergo folding deformation and/or reorientation to a more vertical orientation as axial forces are applied and the compressible sealing element 350 is pressed between the floating retainer ring 360 and the radial shoulder surface 368. As this folding and/or reorientation takes place, the compressible sealing element 350 will also be urged to press against the opposing surfaces of the male adaptor 312 and the connector housing 314 and establish the desired sealed condition.

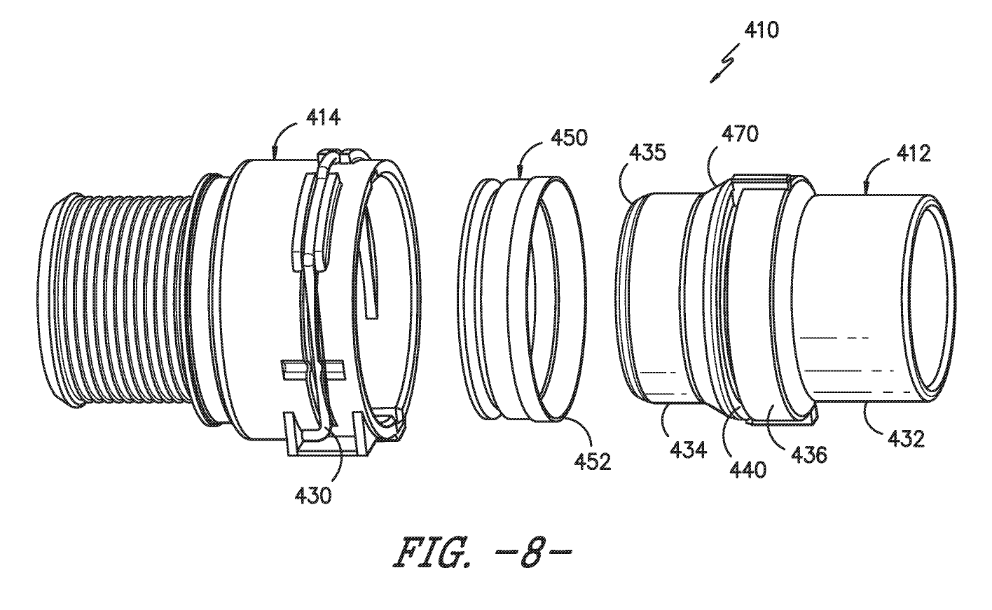

It is also contemplated that the use of a floating retainer ring may be eliminated if desired. By way of example only, and not limitation, FIGS. 6-8 illustrate one exemplary construction for a quick connector assembly 410 consistent with the present disclosure and wherein no floating retainer ring is used. In FIGS. 6-8, elements corresponding to those previously described will be designated by like reference numerals within a 400 series. As illustrated, the quick connector assembly 410 includes a male adaptor 412 and a connector housing 414 defining an axial through bore. The male adaptor 412 and the connector housing 414 are adapted for mated engagement as best illustrated in FIGS. 7 and 8.

As shown, the male adaptor 412 may include a proximal end 432 which matedly engages a hose or other structure (not shown). The male adaptor 412 may also include a flared distal end 434 having a rounded nose 435 which is adapted for insertion into the connector housing 414. In the illustrated exemplary construction, an enhanced diameter intermediate collar 436 is disposed between the proximal end 432 and the distal end 434. A radial groove 440 may be disposed within the intermediate collar 436 for engagement with the spring clamp 430.

Referring jointly to FIGS. 6-8, it may be seen that the illustrated, exemplary quick connector assembly 410 includes a compressible sealing element 450 adapted for disposition in sealing relation between the distal end 434 of the male adaptor and an interir surface of the connector housing 414. As can be best seen through joint reference to FIGS. 6 and 7, the compressible sealing element 450 may be a generally ring-shaped structure with a cross-section adapted for folding deformation upon the application of compression in the axial direction. In this regard, the cross-section of the compressible sealing element 450 may define one or more leg segments intersecting to form living hinges to facilitate such folding deformation. Such leg segments may be characterized by a length to thickness ratio greater than about 1.2 and more preferably a length to thickness ratio greater than about 2.0 and more preferably a length to thickness ratio greater than about 3.0.

Prior to insertion of the male adaptor 412 into the connector housing 414, the compressible sealing element 450 may be disposed in resting relation within the interior of the connector housing 414 adjacent to a supporting radial shoulder surface. The compressible sealing element 450 may be formed from an elastomer with sufficient dimensional stability such that the sealing element 450 maintains a general ring structure within the connector housing 414 prior to use and does not fall out.

As illustrated, in the exemplary construction, the male adaptor 412 may include a forward projecting sloped shoulder surface 470 defining a portion of the flared distal end 434 in spaced apart relation to the rounded nose 435. The sloped shoulder surface 470 of the male adaptor 412 is adapted to contact and bear against the rear face 452 of the compressible sealing element 450 in the final assembled condition. As shown, the sloped shoulder surface 470 and the rear face 452 of the compressible sealing element 450 may have generally complementary angles such that they may slide over one another as the male adaptor is being inserted into the final sealed condition illustrated in FIG. 8. In this final condition, the compressible sealing element 450 may be deformably compressed between the sloped shoulder surface 470 of the male adaptor and and an opposing radial shoulder surface 468 in the connector housing, thereby providing a fluid-tight seal. At the same time, axial withdrawal of the adaptor 412 may be blocked by engagement between the spring clamp 430 and the radial groove 440 in the same manner as described in relation to FIG. 1.

Of course, variations and modifications of the foregoing are within the scope of the present disclosure. The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A quick connector assembly comprising:
a connector housing defining an axial through bore having a housing entrance;
a male adaptor adapted for insertion into the connector housing through the housing entrance in substantially coaxial relation with the axial through bore, the male adaptor comprising a flared distal end having a nose portion; and
a compressible sealing element having a substantially non-circular, cross-sectional profile disposed at a position within the connector housing, wherein upon initial insertion of the male adaptor into the connector housing, the nose portion of the male adaptor is adapted to pass the compressible sealing element, and wherein upon continued insertion of the male adaptor into the connector housing, the compressible sealing element is deformed by folding or reoriented to form a fluid-tight seal between the male adaptor and an opposing surface of the connector housing.

2. The quick connector assembly as recited in claim 1, wherein the nose portion is rounded.

3. The quick connector assembly as recited in claim 1, wherein the flared distal end comprises a sloped shoulder surface in spaced-apart relation from the nose portion.

4. The quick connector assembly as recited in claim 1, wherein the male adaptor further comprises a proximal end adapted to engage a hose.

5. The quick connector assembly as recited in claim 4, wherein the male adaptor further comprises an intermediate, enhanced diameter collar disposed between the proximal end and the flared distal end.

6. The quick connector assembly as recited in claim 5, wherein the intermediate collar comprises a radial groove adapted to receive a retaining clamp upon complete insertion of the male adaptor into the connector housing.

7. The quick connector assembly as recited in claim 1, wherein the compressible sealing element comprises an elastomer ring having a deformable cross section.

8. The quick connector assembly as recited in claim 7, wherein the deformable cross section defines at least one living hinge which deforms by folding upon the application of axial force in the direction of insertion of the male adaptor.

9. The quick connector assembly as recited in claim 1, further comprising a floating retainer ring disposed within the connector housing between the compressible sealing element and the housing entrance.

10. The quick connector assembly as recited in claim 9, wherein the floating retainer ring comprises a rear sloped face.

11. The quick connector assembly as recited in claim 9, wherein the compressible sealing element is deformed or reoriented between the floating retainer ring and a radial shoulder surface of the connector housing.

12. A quick connector assembly comprising:
a connector housing defining an axial through bore having a housing entrance;
a male adaptor adapted for insertion into the connector housing through the housing entrance in substantially coaxial relation with the axial through bore, the male adaptor comprising a flared distal end comprising a sloped shoulder surface and terminating at a nose portion;
a compressible sealing element having a deformable cross section disposed at a position within the connector housing, wherein the deformable cross section deforms by folding upon the application of axial force in the direction of insertion of the male adaptor; and
a floating retainer ring disposed within the connector housing between the compressible sealing element and the housing entrance, the floating retainer ring comprising a rear face; wherein upon initial insertion of the male adaptor into the connector housing, the nose portion of the male adaptor is adapted to pass substantially without obstruction through the floating retainer ring and past the compressible sealing element, and wherein upon continued insertion of the male adaptor into the connector housing, a portion of the male adaptor rearward from the nose portion engages the rear face of the floating retainer ring and moves the floating retainer ring into compressing relation against the compressible sealing element such that the compressible sealing element is deformed or reoriented between the floating retainer ring and a radial shoulder surface of the connector housing.

13. The quick connector assembly as recited in claim 12, wherein the nose portion is rounded.

14. The quick connector assembly as recited in claim 12, wherein the flared distal end comprises a sloped shoulder surface in spaced-apart relation from the nose portion.

12. k connector assembly as recited in claim 12, wherein the male adaptor further comprises a proximal end adapted to engage a hose.

16. The quick connector assembly as recited in claim 15, wherein the male adaptor further comprises an intermediate, enhanced diameter collar disposed between the proximal end and the flared distal end.

17. The quick connector assembly as recited in claim 16, wherein the intermediate collar comprises a radial groove adapted to receive a retaining clamp upon complete insertion of the male adaptor into the connector housing.

18. The quick connector assembly as recited in claim 12, wherein the compressible sealing element comprises an elastomer ring having a deformable cross section.

19. The quick connector assembly as recited in claim 12, wherein the deformable cross section includes leg segments intersecting to define at least one living hinge which deforms by folding upon the application of axial force in the direction of insertion of the male adaptor.

20. A quick connector assembly comprising:
a connector housing defining an axial through bore having a housing entrance;
a male adaptor adapted for insertion into the connector housing through the housing entrance in substantially coaxial relation with the axial through bore, the male adaptor comprising a flared distal end comprising a sloped shoulder surface and terminating at a rounded nose portion, the male adaptor further comprising a proximal end adapted to engage a hose and an intermediate collar disposed between the proximal end and the flared distal end, the intermediate collar including a radial groove adapted to receive a retaining clamp upon complete insertion of the male adaptor into the connector housing;
a compressible sealing element comprising an elastomer ring having a deformable cross section disposed at a position within the connector housing, wherein the deformable cross section deforms by folding upon the application of axial force in the direction of insertion of the male adaptor; and
a floating retainer ring disposed within the connector housing between the compressible sealing element and the housing entrance, the floating retainer ring having a wedge-shaped cross section comprising a rear sloped face adapted to engage the sloped shoulder surface; wherein upon initial insertion of the male adaptor into the connector housing, the nose portion of the male adaptor is adapted to pass substantially without obstruction through the floating retainer ring and past the compressible sealing element, and wherein upon continued insertion of the male adaptor into the connector housing, the sloped shoulder surface of the male adaptor rearward from the nose portion engages the floating retainer ring and moves the floating retainer ring into compressing relation against the compressible sealing element such that the compressible sealing element is deformed or reoriented between the floating retainer ring and a radial shoulder surface of the connector housing.
